(19) United States
(12) Patent Application Publication
(10) Pub. No.: US 2025/0216524 A1
(43) Pub. Date: Jul. 3, 2025

(54) METHOD FOR DETECTING NOISE POINT OF A LIDAR, LIDAR AND MEDIUM

(71) Applicant: SUTENG INNOVATION TECHNOLOGY CO., LTD., Shenzhen (CN)

(72) Inventor: Yalun ZHANG, Shenzhen (CN)

(73) Assignee: SUTENG INNOVATION TECHNOLOGY CO., LTD., Shenzhen (CN)

(21) Appl. No.: 18/918,029

(22) Filed: Oct. 16, 2024

(30) Foreign Application Priority Data
Dec. 28, 2023 (CN) 202311844190.0

(51) Int. Cl. G01S 7/497; G01S 17/08

(52) U.S. Cl. CPC G01S 7/497; G01S 17/08

(57) ABSTRACT

The present application provides a method, a detection device, a LiDAR, and a medium for detecting LiDAR noise points. The method includes: obtaining multiple candidate determination values according to the characteristic parameters of the current data point and the characteristic parameters of M data points in the neighborhood window of the current data point; determining the target determination value of the current data point from multiple candidate determination values; and determining whether the current data point is a noise point according to the target determination value.

### CROSS-REFERENCE TO RELATED APPLICATION

The present application claims the benefit of priority to Chinese Patent Application No. 202311844190.0, filed on Dec. 28, 2023, which is hereby incorporated by reference in its entirety.

### TECHNICAL FIELD

The present application relates to the field of LiDAR detection, and to a method for detecting noise point of a LiDAR, a LiDAR, and a medium in the field of LiDAR detection.

### TECHNICAL BACKGROUND

In the field of detection, LiDAR has been widely used in the fields of intelligent robots, unmanned vehicle driving, etc., due to its advantages of high resolution, good concealment, and strong anti-interference ability.

When the LiDAR is detecting real objects, if there is heavy rain and fog or dense dust in the detection environment, the detection signal emitted by the LiDAR will be reflected by the rain, fog, and dust in addition to the real objects. As a result, in addition to the real object points, there are also noise points such as rain, fog, and dust in the point cloud data obtained by the LiDAR, which affects the detection effect and accuracy of the LiDAR. In the process of LiDAR detection, how to accurately identify noise points in the point cloud and improve the detection accuracy of LiDAR has become an urgent problem to be solved.

### SUMMARY

Embodiments of the present application provide a method for detecting noise point of a LiDAR, detection device, LiDAR, and medium, which can determine the target determination value of the current data point from multiple candidate determination values through the characteristic parameters of multiple data points in the neighborhood window of the current data point, thereby ensuring the accuracy of the target determination value determination. Further, by combining the target determination value to determine whether the current data point is a noise point, the noise points in the point cloud can be accurately identified, thereby improving the detection accuracy of the LiDAR.

In a first aspect, a method for detecting noise point of a LiDAR is provided, the method including: obtaining a plurality of candidate determination values based on characteristic parameter of a current data point and characteristic parameters of M data points within a neighborhood window of the current data point, where the M data points are other data points within the neighborhood window of the current data point except the current data point, and M is an integer greater than 1; determining a target determination value of the current data point from the plurality of candidate determination values based on the characteristic parameters of the current data point and the characteristic parameters of the M data points; and determining whether the current data point is a noise point based on the target determination value.

In an embodiment, the characteristic parameter includes a distance value and a reflectivity characteristic value, and obtaining a plurality of candidate determination values based on the characteristic parameter of the current data point and the characteristic parameters of M data points within a neighborhood window of the current data point includes: obtaining a weighted distance difference value set, based on the distance value of the current data point, the distance values of the M data points, and the reflectivity characteristic value of the M data points; and obtaining the plurality of candidate determination values based on the weighted distance difference value set.

In an embodiment, obtaining a weighted distance difference value set based on the distance value of the current data point, the distance values of the M data points and the reflectivity characteristic value of the M data points includes: calculating the absolute value of the differences between the distance values of the M data points and the distance value of the current data point, to obtain M distance difference absolute values, and to form a distance difference value set; obtaining M weight coefficients based on the reflectivity characteristic values of the M data points, to form a weight coefficient set; and multiplying the distance difference absolute value in the distance difference set with the corresponding weight coefficient in the weight coefficient set, to obtain M weighted distance differences, and to form the weighted distance difference value set.

In an embodiment, the obtaining M weight coefficients, according to the reflectivity characteristic values of the M data points, to form a weight coefficient set includes: when the reflectivity characteristic value Ref(i) of the ith data point meets the high reflectivity requirement, the weight coefficient is calculated as 0.5/Ref(i)^{1/2}; when the reflectivity characteristic value Ref(i) of the ith data point meets the low reflectivity requirement, the weight coefficient is calculated as 1/Ref(i)^{1/2}.

In an embodiment, obtaining the plurality of candidate determination values according to the weighted distance difference value set includes: determining an average value of the X weighted distance difference values with the smallest values in the weighted distance difference value set, as a first candidate determination value; determining an average value of the Y weighted distance difference values with the smallest values in the weighted distance difference value set, as a second candidate determination value; and determining an average value of the Z weighted distance difference values with the smallest values in the weighted distance difference value set, as a third candidate determination value, where X<Y<Z≤M, and X, Y, and Z are all positive integers.

In an embodiment, determining the target determination value of the current data point from the plurality of candidate determination values based on the characteristic parameter of the current data point and the characteristic parameters of the M data points includes: when the reflectivity characteristic values of at least two data points among the M data points meet preset requirements, determining the target determination value as the first candidate determination value; when the reflectivity characteristic values of at least two data points among the M data points do not meet the preset requirements, determining the target determination value based on the characteristic parameter of the current data point.

In an embodiment, the characteristic parameter includes a height value; determining the target determination value based on the characteristic parameter of the current data point includes: when the height value of the current data point is less than or equal to a ground height threshold, determining the target determination value as the first candidate determination value; when the height value of the current data point is greater than the ground height threshold, determining the target determination value based on the distance value of the current data point.

In an embodiment, determining the target determination value based on the distance value of the current data point includes: when the distance value of the current data point is within a first distance interval, determining the target determination value as the second candidate determination value; when the distance value of the current data point is within a second distance interval, determining the target determination value as the third candidate determination value. The maximum value of the second distance interval is less than or equal to the minimum value of the first distance interval.

In an embodiment, determining the target determination value based on the characteristic parameter of the current data point includes: performing histogram statistics on the height values of the M data points according to N height intervals, to obtain N statistical values; and determining the upper limit value of the height interval corresponding to the maximum value of the N statistical values, as the ground height threshold. N is an integer greater than 1.

In an embodiment, determining whether the current data point is a noise point based on the target determination value includes: when the target determination value is greater than or equal to a determination threshold, determining that the current data point is a noise point; when the target determination value is less than the determination threshold, determining that the current data point is not a noise point.

In a second aspect, a LiDAR noise detection device is provided, which includes: an obtaining module, configured to obtain a plurality of candidate determination values according to a characteristic parameter of a current data point and the characteristic parameters of M data points within a neighborhood window of the current data point, where the M data points are other data points within the neighborhood window of the current data point except the current data point, and M is an integer greater than 1; a target determination value determination module, used to determine a target determination value of the current data point from the plurality of candidate determination values based on the characteristic parameter of the current data point and the characteristic parameters of the M data points; and a noise point determination module, used to determine whether the current data point is a noise point based on the target determination value.

In a third aspect, a LiDAR is provided, including a memory and a processor. The memory is used to store executable program code, and the processor is used to call and run the executable program code from the memory, so that the LiDAR executes the method embodiments.

In a fourth aspect, a computer program product is provided, including: a computer program code, which, when executed on a computer, enables the computer to execute the method embodiments.

In a fifth aspect, a computer-readable storage medium is provided, which stores a computer program code. When the computer program code runs on a computer, the computer executes the method embodiments.

In an embodiment of the present application, multiple candidate determination values are obtained through the characteristic parameter of the current data point and the characteristic parameters of the M data points within the neighborhood window of the current data point. The target determination value of the current data point is determined from the multiple candidate determination values in combination with the characteristic parameter of the current data point and the characteristic parameters of the M data points. The selection of the target determination value corresponding to the current data point from the multiple candidate determination values can ensure a high degree of match between the target determination value and the current data point, and ensure the accuracy and rationality of the determination of the target determination value. The target determination value is used to determine whether the current data point is a noise point, and screening and determination are performed according to the characteristics of the noise point distribution in rain, fog, or dust, so as to effectively identify the noise points in the point cloud and improve the detection accuracy of the LiDAR.

### BRIEF DESCRIPTION OF DRAWINGS

FIG. 1 is a schematic diagram of a scene of LiDAR noise detection provided in an embodiment of the present application;

FIG. 2 is a schematic flow chart of a method for detecting LiDAR noise provided in an embodiment of the present application;

FIG. 3 is a schematic diagram of a scenario for selecting data points within a neighborhood window provided by an embodiment of the present application;

FIG. 4 is a schematic flow chart of another method for detecting LiDAR noise provided in an embodiment of the present application;

FIG. 5 is a schematic diagram of the structure of a LiDAR noise detection device provided in an embodiment of the present application; and

FIG. 6 is a schematic diagram of the structure of a LiDAR provided in an embodiment of the present application.

### DETAILED DESCRIPTION

The technical solution will be described in conjunction with the accompanying drawings. In the description of the embodiments, unless otherwise specified, “/” means or, for example, A/B can mean A or B: “and/or” in the text is a description of the association relationship of associated objects, indicating that there can be three relationships, for example, A and/or B can mean: A exists alone, A and B exist at the same time, and B exists alone. In addition, in the description of the embodiments, “multiple” means two or more than two.

The terms “first” and “second” are used for descriptive purposes only and are not to be understood as suggesting or implying relative importance or implicitly indicating the number of technical features indicated. Thus, a feature defined as “first” or “second” may explicitly or implicitly include one or more of the features.

LiDAR: A radar system that uses laser beams to detect the position, speed, and other characteristic quantities of a target. It is to emit a detection signal (laser beam or detection light) to a target object, and then receive the echo signal reflected from the target object, and obtain the position information of the target object based on the detection signal and the echo signal, such as distance, direction, height, speed, attitude, and even shape.

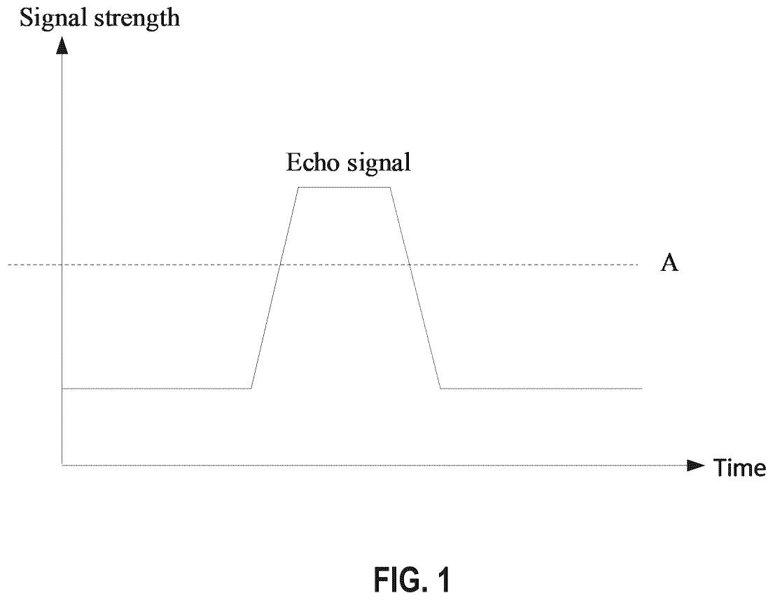

When identifying noise points in the point cloud collected by the LiDAR, it is achieved through the method shown in FIG. 1 below.

FIG. 1 is a schematic diagram of a scene of LiDAR noise detection provided in an embodiment.

As shown in FIG. 1, during operation, the LiDAR first emits a detection signal. When encountering an object, the detection signal is reflected by the object, and the LiDAR obtains an echo signal.

After obtaining the echo signal, the echo signal is detected and processed. According to the sampling result of the detection, the LiDAR can obtain relevant information of the object.

Affected by weather factors, in addition to real objects, there may be impurity objects such as dust, rain, and fog in the air. In an embodiment, real objects refer to objects that can collect valid data during the detection process of the LiDAR, such as vehicles, pedestrians, curbs, ground, road signs, buildings, etc., on the road. During detection process of the LiDAR, the detection signal can be reflected by real objects on the one hand, and by impurity objects on the other hand. In other words, the echo signal received by the LiDAR includes both the echo signal corresponding to the real object and the echo signal corresponding to the impurity object. When the LiDAR processes the echo signal, the point cloud obtained includes data points of real objects (hereinafter referred to as “real object points”) and data points of impurity objects (hereinafter referred to as noise points). The noise points in the point cloud will interfere with the subsequent object recognition and determination based on the point cloud, resulting in the detection accuracy of the LiDAR being affected.

As shown in FIG. 1, in order to remove noise in the point cloud, the LiDAR can perform filtering during the detection process after receiving the echo signal to remove the echo signal corresponding to the impurity object in the echo signal.

In one implementation, it is achieved by setting a suitable detection threshold. For example, a detection threshold is set to threshold A, and the value of threshold A is relatively small. When the echo signal is received, the echo signal strength of the real object is relatively large, usually greater than threshold A, and can be sampled; the echo signal strength of the impurity object is relatively small, and the echo signal less than threshold A will not be sampled. By setting a suitable detection threshold, the echo signal with a signal strength less than threshold A is filtered out, so as to play the role of filtering out the echo signal of the impurity object.

When using the above method for filtering and de-noising, if the detection threshold is set too high, it may cause real objects to be missed, especially real objects at a long distance or real objects with low reflectivity, whose echo signal intensity is small, resulting in real objects being mistakenly deleted; if the detection threshold is set too low, the noise points cannot be effectively filtered out.

An embodiment of the present application provides a method for detecting LiDAR noise points, which can determine the target determination value of the current data point from multiple candidate determination values through the characteristic parameters of multiple data points in the neighborhood window of the current data point, thereby ensuring the accuracy and rationality of the target determination value determination. By combining the target determination value to determine whether the current data point is a noise point, the noise points in the point cloud can be accurately identified, thereby improving the detection accuracy of the LiDAR.

For noise points in the point cloud, they are generally densely distributed above the ground within a distance range that is less than a preset distance. Based on the above distribution characteristics of noise points in the point cloud, for data point in the point cloud, when determining whether the current data point is a noise point, a distance value of the current data point can be compared and determined. If the distance value of the current data point is greater than or equal to the preset distance, the LiDAR determines that the current data point is not a noise point; if the distance value of the current data point is less than the preset distance, the LiDAR determines that the current data point may be a noise point, and further determination is performed on the current data point. The preset distance can be obtained based on data statistics, for example, the preset distance can be 50 m.

In the case where the current data point may be a noise point, the LiDAR can further determine whether the current data point is a noise point by the method of an embodiment of the present application.

The following describes a method for detecting LiDAR noise points provided in an embodiment of the present application.

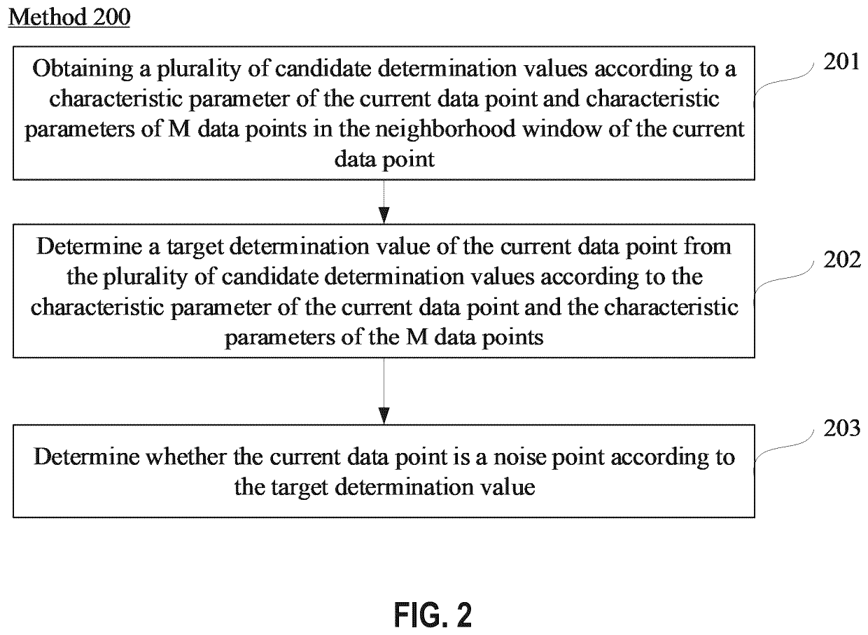

FIG. 2 is a schematic flowchart of a method for detecting LiDAR noise points provided in an embodiment of the present application.

As shown in FIG. 2, the method 200 includes the following steps 201 to 203.

Step 201, obtaining a plurality of candidate determination values according to a characteristic parameter of the current data point and characteristic parameters of M data points in the neighborhood window of the current data point, where the M data points are other data points in the neighborhood window of the current data point except the current data point, and M is an integer greater than 1.

During the detection process, when the LiDAR completes a scanning cycle to scan the entire field of view, a frame of point cloud is obtained, and a frame of point cloud includes all data points detected in the entire field of view.

Characteristic parameters of data point may include three-dimensional coordinates, reflectivity characteristic values, speed, grayscale information, etc. In an embodiment, the characteristic parameters of the data point include three-dimensional coordinates and reflectivity characteristic values. The three-dimensional coordinates of the data point refer to the three-dimensional coordinates of the data point in the LiDAR coordinate system. There are many ways to establish the LiDAR coordinate system. For example, the LiDAR coordinate system can be a center of the scanning device for scanning the LiDAR deflection detection beam as the coordinate origin O, the X axis is horizontal to the left, the Y axis is vertically upward, and the Z axis is in the forward direction of the LiDAR. Under the LiDAR coordinate system, the coordinates of any data point i in the point cloud are marked as (Xi, Yi, Zi). Xi represents the distance between the data point i and the YOZ plane, that is, the horizontal value of the data point i; Yi represents the distance between the data point i and the XOZ plane, that is, the height value of the data point i; Zi represents the distance between the data point i and the XOY plane, that is, the distance value calculated by the flight time between the emission time of the detection signal and the reception time of the echo signal of the data point i. The reflectivity characteristic value refers to the reflectivity of the object detected by the LiDAR, which is denoted as Ref(i). In an embodiment, the reflectivity characteristic value of the noise point meets the low reflectivity requirement, and the reflectivity characteristic value of the real object point meets the high reflectivity requirement.

When determining whether the current data point is a noise point, the LiDAR can select M data points in the neighborhood window with the current data point as the center point. The M data points are other data points in the neighborhood window except the current data point, and M is an integer greater than 1.

In an embodiment, a size of the neighborhood window is 5*5, which can be adjusted.

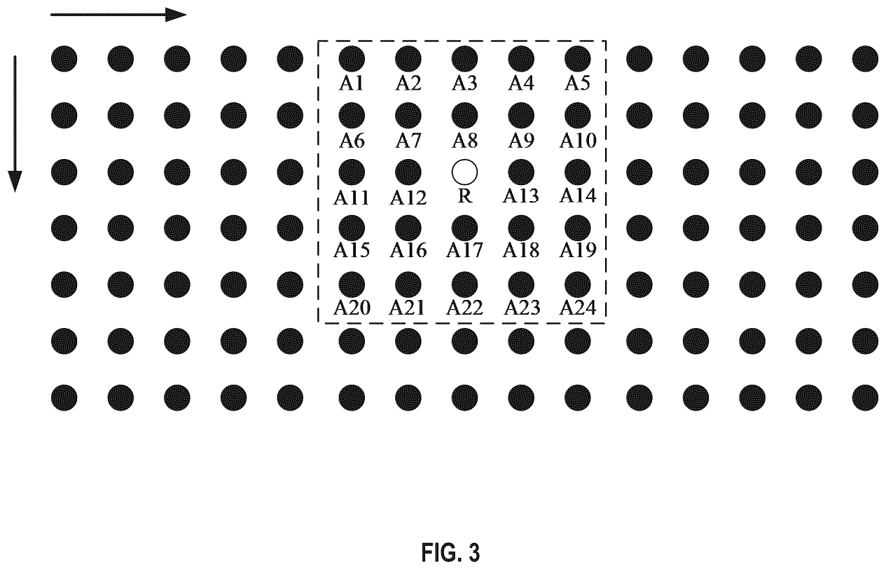

FIG. 3 is a schematic diagram of a scenario for selecting data points within a neighborhood window provided in an embodiment of the present application.

For example, as shown in FIG. 3, a current frame point cloud includes multiple data points, and each data point is numbered from left to right and from top to bottom. In the current frame point cloud, data point i has m rows and n columns.

A current data point R is the 38th data point among the multiple data points, the number of rows m=3, and the number of columns n=8.

When selecting the neighborhood window of the current data point, the LiDAR can select multiple data points within a 5*5 neighborhood window with the current data point R as the center, that is, 25 data points from the 1st row to the 5th row and the 6th column to the 10th column, where M=24.

As shown in FIG. 3, the 24 data points are recorded as “A1, A2, . . . A24” from left to right and from top to bottom.

The LiDAR can determine multiple candidate determination values based on the characteristic parameter of the current data point and the characteristic parameters of the 24 data points.

When the LiDAR calculates multiple candidate determination values, the characteristic parameters include distance values and reflectivity characteristic values.

In an implementation, multiple candidate determination values are obtained according to the characteristic parameter of the current data point and the characteristic parameters of M data points within the neighborhood window of the current data point, including the following steps 2011 and 2012.

Step 2011, obtaining a weighted distance difference value set according to the distance value of the current data point, the distance values of the M data points and the reflectivity characteristic values of the M data points.

Step 2012: Obtain multiple candidate determination values according to the weighted distance difference value set.

When calculating the weighted distance difference values, if the current data point is a real object point, the higher the similarity between the current data point and the data points in the neighborhood, the smaller the weighted distance difference value is obtained; if the current data point is a noise point, the lower the similarity between the current data point and the data points in the neighborhood, the larger the weighted distance difference value is obtained. By calculating the weighted distance difference value, the difference between each data point in the neighborhood and the current data point is reflected.

In the process of obtaining the weighted distance difference value set, the M distance difference absolute values are determined, and the reflectivity characteristic value is used as the weight coefficient, and the weighted distance difference value set is obtained according to the distance difference absolute value and the corresponding weight coefficient. In an implementation, the weighted distance difference value set is obtained according to the distance value of the current data point, the distance values of the M data points, and the reflectivity characteristic value of the M data points, including the following steps 20111-20113.

Step 20111, calculate the absolute values of the differences between the distance values of the M data points and the distance value of the current data point, to obtain M absolute values of the distance differences, and to form a distance difference set.

Exemplarily, the current data point R shown in FIG. 3 and the other 24 data points in the neighborhood window with the current data point R as the center are taken as an example for explanation, in which M=24. The distance value of the current data point is recorded as ZR, and the 24 distance values corresponding to the 24 data points are recorded as ZA1, ZA2, ZA3, . . . ZA24. The absolute values of the differences between the 24 distance values and ZR are calculated to obtain 24 distance difference absolute values, and the 24 distance difference absolute values are recorded as Z (A1)_dif, Z (A2)_dif, Z (A3)_dif . . . , Z (A24)_dif, respectively. The 24 distance difference absolute values form a distance difference set, and the distance difference set is recorded as Zdif.

In an embodiment, the distance difference set Zdif can be expressed by the following expression (1):

$${Z}_{dif} = \{ {Z}_{( A 1 ) \_ dif} , {Z}_{( A 2 ) \_ dif} , {Z}_{( A 3 ) \_ dif} , … , {Z}_{( A 24 ) \_ dif} \} \qquad ( 1 )$$

Through the above process, the LiDAR can obtain the distance difference set Z dif.

Step 20112, based on the reflectivity characteristic values of the M data points, M weight coefficients are obtained to form a weight coefficient set.

After obtaining the distance difference value set, considering the influence of the reflectivity characteristic value on the data point detection, 24 weight coefficient sets are obtained based on the reflectivity characteristic value of each of the 24 data points.

In an implementation, M weight coefficients are obtained according to the reflectivity characteristic values of M data points to form a weight coefficient set, which can be obtained by the following steps.

When the reflectivity characteristic value Ref(i) of the ith data point meets the high reflectivity requirement, the calculated weight coefficient is 0.5/Ref(i)^{1/2}. When the reflectivity characteristic value Ref(i) of the ith data point meets the low reflectivity requirement, the calculated weight coefficient is 1/Ref(i)^{1/2}.

A LIDAR can use multiple detection thresholds to sample echo signals, such as a first threshold and a second threshold, where the first threshold is greater than the second threshold, the first threshold is a high threshold and the second threshold is a low threshold. When the intensity of the echo signal is large, it can be sampled by both the first threshold and the second threshold at the same time; the probability that the echo signal is reflected by a real object is greater, and its output reflectivity characteristic value is an even number, meeting the high reflectivity requirement. When the intensity of the echo signal is small, it can be sampled by the second threshold but not by the first threshold; the probability that the echo signal is reflected by an impurity object is greater, and its output reflectivity characteristic value is an odd number, meeting the low reflectivity requirement.

The reflectivity characteristic value can be obtained based on the reflectivity value output by the LiDAR, after sampling the echo signal using two detection thresholds. Since the LiDAR originally outputs a binary reflectivity code, the binary reflectivity code is converted into a decimal reflectivity code, which is the reflectivity characteristic value.

Therefore, based on whether the reflectivity characteristic value of each data point among the 24 data points is an odd value or an even value, the LiDAR can determine the weight coefficient of each data point. In an embodiment, the weight coefficient of the data point can be expressed by the following expression (2).

$${W}_{( i )} = \{ \begin{matrix}\frac{1}{\sqrt{Ref ( i )}} ; \\ \frac{0.5}{\sqrt{Ref ( i )}} ;\end{matrix} \qquad ( 2 )$$

W (i): the weight coefficient of any data point i among the 24 data points, as shown in FIG. 3, i ranges from A 1 to A24;
Ref(i): reflectivity characteristic value of data point i.

Through the above process, the LiDAR can obtain the weight coefficient corresponding to each of the 24 data points. The 24 weight coefficients form a weight coefficient set, denoted as W.

In an embodiment, the weight coefficient set W can be expressed by the following expression (3).

$$W = \{ {W}_{( A 1 )} , {W}_{( A 2 )} , {W}_{( A 3 )} , … , {W}_{( A 24 )} \} \qquad ( 3 )$$

Through the above processes, the LiDAR can obtain the weight coefficient set W.

Step 20113, multiplying the absolute value of the distance difference in the distance difference value set by the corresponding weight coefficient in the weight coefficient set, to obtain M weighted distance difference values, and to form a weighted distance difference value set.

When determining the weighted distance difference value set according to the distance difference value set and the weight coefficient set, for any one of the 24 data points, determine the distance difference absolute value corresponding to the data point from the distance difference value set, and determine the weight coefficient corresponding to the data point from the weight coefficient set, and then multiply the distance difference absolute value corresponding to the data point with the weight coefficient corresponding to the data point, to obtain the weighted distance difference value corresponding to the data point. Thus, 24 weighted distance difference values corresponding to the 24 data points are obtained, which form the weighted distance difference value set.

As shown in FIG. 3, for data point A1 among the 24 data points, in the distance difference value set Z dif, the LiDAR can determine that the absolute value of the distance difference corresponding to data point A1 is Z (A1)_dif. In the weight coefficient set W, the LiDAR can determine that the weight coefficient corresponding to data point A1 is W (A1), and the above distance difference absolute value Z (A1)_dif and the weight coefficient W (A1) are multiplied to obtain the weighted distance difference corresponding to data point A1, which is recorded as Q (A1).

The process of determining the weighted distance difference values corresponding to other data points is similar as the process of determining the weighted distance difference value of data point A1.

Through the above process, the LiDAR can obtain a weighted distance difference value set, denoted as Q.

In an embodiment, the weighted distance difference value set Q can be expressed by the following expression (4).

$$Q = \{ {Q}_{( A 1 )} , {Q}_{( A 2 )} , {Q}_{( A 3 )} , … , {Q}_{( A 24 )} \} \qquad ( 4 )$$

According to the elements included in the weighted distance difference value set and the number of candidate determination values, the multiple candidate determination values may include a first candidate determination value, a second candidate determination value, and a third candidate determination value.

In an implementation, multiple candidate determination values are obtained based on a weighted distance difference value set, including the following steps 20121 to 20123.

Step 20121: determine an average value of X smallest weighted distance difference values in the weighted distance difference value set as the first candidate determination value.

Step 20122: determine an average value of Y smallest weighted distance difference values in the weighted distance difference value set as the second candidate determination value.

Step 20123: determine an average value of Z smallest weighted distance difference values in the weighted distance difference value set as the third candidate determination value, where X<Y<ZEM and X, Y, and Z are all positive integers.

In an embodiment, X=3, Y=6, Z=15.

Exemplarily, in the process of determining the first candidate determination value, the second candidate determination value, and the third candidate determination value, for the 24 weighted distance difference values in the weighted distance difference value set, the LiDAR can sort the 24 weighted distance difference values in order of numerical value, to obtain a sorted weighted distance difference value set Q′.

The first candidate determination value refers to an average value of the three smallest weighted distance difference values in the weighted distance difference value set Q′. When the weighted distance difference values in the weighted distance difference value set Q′ are sorted from small to large, the average value of the first three weighted distance difference values in Q′ is taken as the first candidate determination value and is recorded as “E1”; the second candidate determination value refers to an average value of the first six weighted distance difference values in Q′ and is recorded as “E2”; the third candidate determination value refers to an average value of the first 15 weighted distance difference values in Q′ and is recorded as “E3”.

E1, E2, and E3 can be expressed by the following expressions (5), respectively.

$$E = \{ \begin{matrix}{E}_{1} = \frac{{\sum }_{i = 1}^{3} {Q}_{( i )}^{′}}{3} , \\ {E}_{2} = \frac{{\sum }_{i = 1}^{6} {Q}_{( i )}^{′}}{6} , \\ {E}_{3} = \frac{{\sum }_{i = 1}^{15} {Q}_{( i )}^{′}}{15}\end{matrix} , \qquad ( 5 )$$

As another example, the LiDAR may not sort the 24 weighted distance differences, but compare the sizes of the values to select 3 weighted distance differences with smaller values, 6 weighted distance differences with smaller values, and 15 weighted distance differences with smaller values from the 24 weighted distance differences, and calculate the average values respectively to obtain the first candidate determination value, the second candidate determination value, and the third candidate determination value.

At this point, the process of determining multiple candidate determination values in step 201 is completed.

From the calculation process of the aforementioned multiple candidate determination values, the first candidate determination value is the smallest, and the third candidate determination value is the largest.

The smaller the distance difference between the M data points in the neighborhood and the current data point, the smaller the corresponding weighted distance difference; when the echo signal strength is large, the reflectivity characteristic value is an even number, and the weight coefficient is also smaller. If the current data point corresponds to a real object, the M data points in its neighborhood are likely to correspond to the same real object, and the M weighted distance differences calculated are generally small. If the current data point corresponds to an impurity object, the M data points in its neighborhood have poor correlation with the current data point, and the M weighted distance differences calculated are generally large.

The LiDAR can determine the target determination value of the current data point from multiple candidate determination values through the following step 202.

Step 202: determine a target determination value of the current data point from the plurality of candidate determination values according to the characteristic parameter of the current data point and the characteristic parameters of the M data points.

When determining the target determination value based on the characteristic parameter of the current data point and the characteristic parameters of M data points, based on the characteristics of the characteristic parameters corresponding to the real object points and noise points in the point cloud, combined with the point cloud characteristics of rain, fog or dust noise points, the LiDAR can determine the matching target determination value through the characteristic parameters of the current data point and the M data points in the neighborhood.

In an implementation, a target determination value of the current data point is determined from a plurality of candidate determination values according to a characteristic parameter of the current data point and characteristic parameters of M data points, including the following steps 2021 to 2022.

Step 2021: when the reflectivity characteristic values of at least two data points among the M data points meet a preset requirement, the target determination value is determined to be a first candidate determination value.

The reflectivity characteristic value satisfying the preset requirement means that the reflectivity characteristic value is an even value greater than zero.

When the reflectivity characteristic value is an even number, the probability that the echo signal is reflected by a real object is relatively high. The current data point corresponds to a real object, and the M data points in its neighborhood also have a high probability of corresponding to the same real object, the correlation between the current data point and the M data points in the neighborhood is strong. When the reflectivity characteristic values of at least 2 data points among the 24 data points are both even numbers, the probability that the current data point is a real object point is relatively high, and the probability that the current data point is a noise point is very low. The first candidate determination value E1 with the weakest constraint is selected as the target determination value E.

Step 2022: when the reflectivity characteristic values of at least two data points among the M data points do not meet the preset requirements, a target determination value is determined according to the characteristic parameters of the current data point.

If the probability that the current data point is not a real object point is high, further determinations need to be made. The LiDAR can combine the characteristic parameters of the current data point to determine the target determination value of the current data point.

In some embodiments, in addition to the distance value and the reflectivity characteristic value, when determining the target determination value, the characteristic parameters also include a height value, that is, Y (i) of the current data point in the LiDAR coordinate system.

In an implementation, the target determination value is determined according to the characteristic parameters of the current data point, including the following steps 20221-20222.

Step 20221, when the height value of the current data point is less than or equal to a ground height threshold, determine the target determination value as the first candidate determination value.

The ground height threshold can be a pre-calibrated reference ground height, but the pre-calibrated reference ground height may not match the scene, such as uphill, downhill, and other scenes where the ground height changes. The ground height threshold can be calculated based on the characteristic value of the data point. The LiDAR can be counted according to the height values of M data points according to different height intervals, and the ground height threshold can be determined according to the height interval where the data points are most concentrated.

In an embodiment, determining the ground height threshold may include the following steps.

First, height values of the M data points are histogram-counted according to N height intervals, to obtain N statistical values, where N is an integer greater than 1.

Taking the above example as an example, N height intervals can be set for the 24 height values corresponding to the 24 data points, for example, the N height intervals can be [a, b), [b, c), [c, d). Based on the preset three height intervals, the height values of the 24 data points are histogram-statisticed, thereby obtaining the three distribution quantities corresponding to the 24 height values in the three height intervals, that is, obtaining three statistical values.

The upper limit value of the height interval corresponding to the maximum value of the N statistical values is determined as the ground height threshold.

After obtaining N statistical values, the LiDAR can determine the maximum value therefrom, that is, determine which height interval among the N height intervals corresponds to the largest number of data points. Since the ground height is continuous and occupies a large range in the field of view, more data points are detected on the ground and the height values are concentrated. By counting the height values of the data points in the neighborhood, the height interval with the most distributed data points can be identified, and the upper limit value of the height interval is determined as the ground height threshold. Exemplarily, if among the three height intervals, the statistical value of 2 to 4 data points in the height interval [b, c) is the largest, the LiDAR can determine the height value c as the ground height threshold.

After determining the ground height threshold, the LiDAR can compare the height value of the current data point with the ground height threshold.

As the noise points are data points corresponding to impurities such as rain, fog, and dust, in the environment, rain, fog, and dust are mostly fine particles with small volume and light weight. The terminal velocity in the air is small. Affected by air convection, this type of impurity is more likely to float in the air than real objects. Therefore, the height value of the noise point is larger than the height value of the ground.

When the height value of the current point is less than or equal to the ground height threshold, the current data point is likely to correspond to the echo signal returned by the ground, and the current data point is a ground point, not a noise point. When the current data point is likely to be a real object point, the first determination value E1 is selected as the target determination value E. Exemplarily, the ground height threshold is c, and if the height value of the current data point is less than or equal to c, the LiDAR determines E1 as the target determination value.

Step 20222, when the height value of the current data point is greater than the ground height threshold, determine the target determination value according to the distance value of the current data point.

When the height value of the current point is greater than the ground height threshold, further determinations need to be made.

Since the distance values of noise points caused by rain, fog, or dust are usually concentrated above the ground with a distance value less than 20 m, and at most there are sporadic points distributed within the range of 20-50 m, the LiDAR can further determine the target determination value based on the distribution characteristics of the distance values of the above noise points.

When the distance value of the current data point is within the first distance interval, the target determination value is determined to be the second candidate determination value. When the distance value of the current data point is within the second distance interval, the target determination value is determined to be the third candidate determination value, and the maximum value of the second distance interval is less than or equal to the minimum value of the first distance interval.

In some embodiments, the first distance interval is [20, 50) and the second distance interval is (0,20). Exemplarily, the distance value of the current data point is 30 m, which is in the first distance interval. Combined with the characteristics of the noise points in the above description that there are at most sporadic distributions within the range of 20-50 m, it is explained that the possibility that the current data point is a noise point is low. Considering the previous determination results, the possibility that the current data point is a noise point is medium, and the LiDAR can determine the second candidate determination value E2 as the target determination value E.

For example, the distance value of the current data point is 10 m, which is in the second distance interval. Combined with the characteristics of the noise points being concentrated above the ground with a distance value less than 20 m in the above description, the current data point is likely to be a noise point. The LiDAR can determine the third candidate determination value E3 as the target determination value E.

At this point, step 202 ends.

Through the above step 202, the LiDAR can determine the target determination value of the current data point from multiple candidate determination values to determine whether the current data point is a noise point. According to the characteristic values of the data points in the neighborhood, for the case where the current data point is likely to be a real object and is less likely to be a noise point, the first candidate determination value with the weakest constraint is determined as the target determination value; for the characteristic value of the data point in the neighborhood that does not meet the real object determination condition, the height value of the current data point is compared, and for the case where the current data point is likely to be a ground point, the first candidate determination value with the weakest constraint is also determined as the target determination value; if both of the above two situations are not satisfied, the current data point is likely to be a noise point. On this basis, the distance of the current data point is further compared, combined with the distance distribution characteristics of the point cloud of rain, fog, and dust, for the current data point that does not meet the distribution characteristics, the second candidate determination value with medium constraints is determined as the target determination value, and for the current data point that meets the distribution characteristics, the third candidate determination value with the strongest constraint is determined as the target determination value.

Step 203: Determine whether the current data point is a noise point according to the target determination value.

After obtaining the target determination value of the current data point, the LiDAR determines whether the current data point is a noise point by comparing the target determination value with the determination threshold. The determination threshold E′ is preset or can be determined based on the candidate determination values calculated from the known detection points of the real object and the candidate determination values calculated from the known noise points.

According to the target determination value, determine whether the current data point is a noise point, include:

When the target determination value is greater than or equal to the determination threshold, the current data point is determined to be a noise point. When the target determination value is less than the determination threshold, the current data point is determined not to be a noise point.

In an embodiment, when the target determination value E is greater than or equal to E′, the LiDAR can determine that the current data point is a noise point. When the target determination value E is less than E′, the LiDAR can determine that the current data point is a valid point such as a real object point or a ground line.

Through the above steps 201 to 203, the LiDAR can realize the process of noise point detection.

If the current detection point is a detection point of a real object, the characteristic parameters of the detection points in its neighborhood have good correlation, and the corresponding M weighted distance difference values are generally small, so the multiple candidate determination values calculated are small. When determining the target determination value from multiple candidate determination values, the first candidate determination value with the weakest constraint is used as the target determination value. When the final target determination value is compared with the determination threshold, it is determined not to be a noise point. If the current detection point is a noise point, the characteristic parameters of the detection points in its neighborhood have poor correlation, and the corresponding M weighted distance difference values are generally large, so the multiple candidate determination values calculated are also large. When determining the target determination value from multiple candidate determination values, since the characteristic parameter characteristics of the current point meet the data characteristics of the point cloud of rain, fog and dust, the second candidate determination value with medium constraints or the third candidate determination value with the strongest constraints is determined as the target determination value. When the final target determination value is compared with the determination threshold, it is determined to be a noise point.

In the embodiment of the present application, a plurality of candidate determination values are obtained by the characteristic parameter of the current data point and the characteristic parameters of the M data points within the neighborhood window of the current data point. Then, the target determination value of the current data point is determined from the plurality of candidate determination values in combination with the characteristic parameters of the current data point and the characteristic parameters of the M data points. The above-mentioned selection of the target determination value corresponding to the current data point from the plurality of candidate determination values can ensure a high degree of match between the target determination value and the current data point, and ensure the accuracy and rationality of the determination of the target determination value. Further, the target determination value is used to determine whether the current data point is a noise point, and the noise point distribution characteristics of rain, fog, or dust are screened and judged to effectively identify the noise points in the point cloud. For the detection points identified as noise points, the LiDAR can remove them and output the de-noised point cloud, which is convenient for the back end to cluster and identify objects based on the output point cloud, and perform the next step of processing to improve the detection accuracy of the LiDAR.

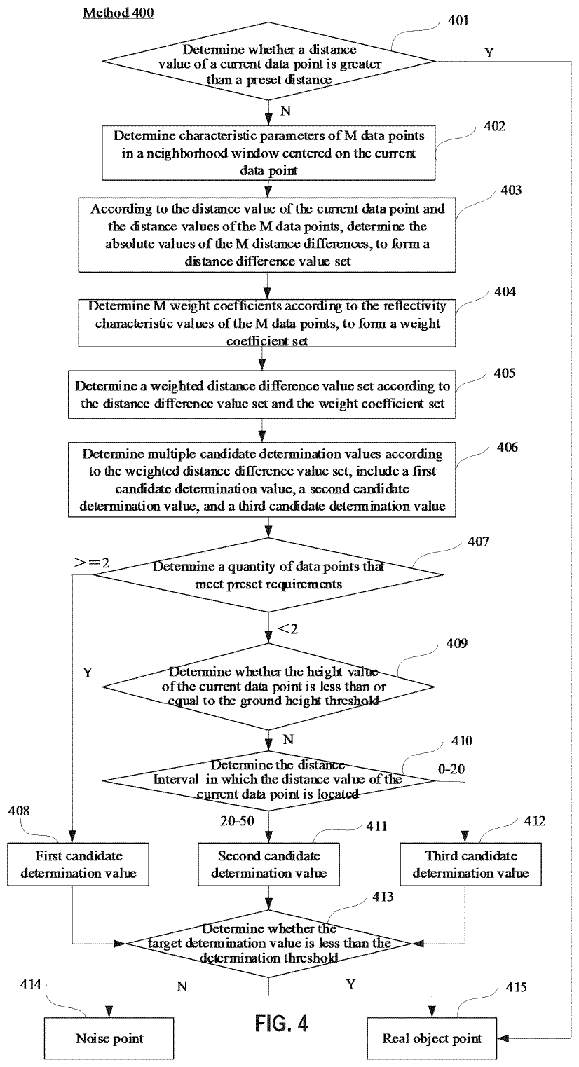

FIG. 4 is a schematic flowchart of a method for detecting LiDAR noise provided in an embodiment of the present application.

As shown in FIG. 4, the method 400 includes the following steps 401 to 415.

Step 401, determine whether a distance value of a current data point is greater than a preset distance.

Based on the distribution characteristics of the distance values of noise points, when identifying the current data point, the LiDAR can first determine whether the distance value of the current data point is greater than the preset distance.

When the distance value of the current data point is greater than the preset distance, step 415 is executed, the current data point is determined to be a real object point.

When the distance value of the current data point is less than or equal to the preset distance, the current data point may be a noise point, and step 402 is performed.

Step 402: determine characteristic parameters of M data points in a neighborhood window centered on the current data point.

Step 403: according to the distance value of the current data point and the distance values of the M data points, determine the absolute values of the M distance differences, to form a distance difference value set.

Step 404: determine M weight coefficients according to the reflectivity characteristic values of the M data points, to form a weight coefficient set.

Step 405: determine a weighted distance difference value set according to the distance difference value set and the weight coefficient set.

Step 406: determine multiple candidate determination values according to the weighted distance difference value set, where the multiple candidate determination values include a first candidate determination value, a second candidate determination value, and a third candidate determination value.

Step 402 to step 406 have the similar processes as step 201 in method 200. Please refer to the description in step 201 for details.

Step 407: determine a quantity of data points that meet preset requirements among the M data points.

When the quantity of data points that meet the preset requirement is greater than or equal to 2, step 408 is executed.

When the quantity of data points that meet the preset requirement is less than 2, step 409 is executed.

Step 408: determine the target determination value as the first candidate determination value.

Step 409: determine whether the height value of the current data point is less than or equal to the ground height threshold.

When the height value of the current data point is less than or equal to the ground height threshold, return to step 408.

When the height value of the current data point is greater than the ground height threshold, step 410 is executed.

Step 410: determine the distance interval in which the distance value of the current data point is located.

When the distance interval of the distance value of the current data point is the first distance interval (0-20 m), step 412 is executed.

When the distance interval of the distance value of the current data point is the second distance interval (20-50), step 411 is executed.

Step 411: determine the target determination value as the second candidate determination value.

Step 412: determine the target determination value as the third candidate determination value.

The above steps 407 to 412 have similar processes as step 202 in method 200. Please refer to the description in step 202 for details.

Step 413: determine whether the target determination value is less than the determination threshold.

When the target determination value is less than the determination threshold, step 415 is executed.

When the target determination value is greater than or equal to the determination threshold, step 414 is executed.

Step 414: determine that the current data point is a noise point.

Step 415: determine that the current data point is a real object point.

Step 413 to step 415 have the similar processes as step 203 in method 200. Please refer to the description in step 2.03 for details.

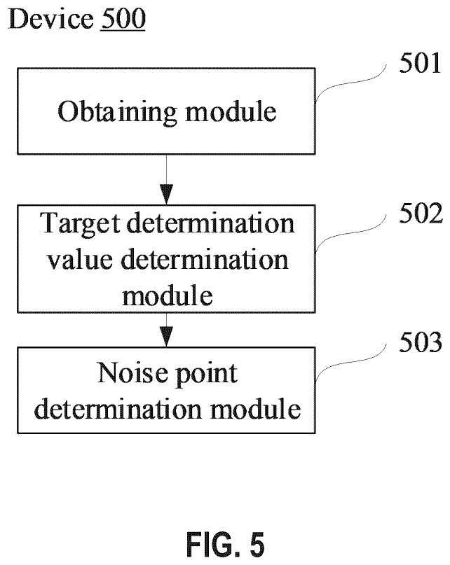

FIG. 5 is a schematic diagram of the structure of a LiDAR noise detection device provided in an embodiment of the present application.

As shown in FIG. 5, the device 500 includes: an obtaining module 501 is used to obtain multiple candidate determination values according to a characteristic parameter of a current data point and characteristic parameters of M data points in a neighborhood window of the current data point, where the M data points are other data points in the neighborhood window of the current data point except the current data point, and M is an integer greater than 1;
a target determination value determination module 502 is used to determine a target determination value of the current data point from the multiple candidate determination values according to the characteristic parameter of the current data point and the characteristic parameters of the M data points; and
a noise point determination module 503 is used to determine whether the current data point is a noise point according to the target determination value.

In one implementation, the characteristic parameters include a distance value and a reflectivity characteristic value. The obtaining module 501 is used to: obtain a weighted distance difference value set based on the distance value of the current data point, the distance values of the M data points, and the reflectivity characteristic values of the M data points; and obtain the multiple candidate determination values based on the weighted distance difference value set.

In one implementation, the obtaining module 501 is used to: calculate the absolute value of the difference between the distance values of the M data points and the distance value of the current data point, obtain M distance difference absolute values, and form a distance difference value set; obtain M weight coefficients according to the reflectivity characteristic values of the M data points, and form a weight coefficient set; multiply the distance difference absolute value in the distance difference value set with the corresponding weight coefficient in the weight coefficient set, and obtain M weighted distance difference values, and form the weighted distance difference value set.

In one implementation, the obtaining module 501 is used to: when the reflectivity characteristic value Ref(i) of the ith data point meets the high reflectivity requirement, calculate the weight coefficient as 0.5/Ref(i)^{1/2}; when the reflectivity characteristic value Ref(i) of the ith data point meets the low reflectivity requirement, calculate the weight coefficient as 1/Ref(i)^{1/2}.

In an implementation, the obtaining module 501 is used to: determine the average value of the X weighted distance difference values with the smallest values in the weighted distance difference value set as the first candidate determination value; determine the average value of the Y weighted distance difference values with the smallest values in the weighted distance difference value set as the second candidate determination value; and determine the average value of the Z weighted distance difference values with the smallest values in the weighted distance difference value set as the third candidate determination value, where X<Y<Z≤M and X, Y, and Z are all positive integers.

In one implementation, the target determination value determination module 502 is used to: when the reflectivity characteristic values of at least two data points among the M data points meet the preset requirements, determine the target determination value as the first candidate determination value; when the reflectivity characteristic values of at least two data points among the M data points do not meet the preset requirements, determine the target determination value according to the characteristic parameters of the current data point.

In one implementation, the characteristic parameter includes a height value. The target determination value determination module 502 is used to: when the height value of the current data point is less than or equal to the ground height threshold, determine the target determination value as the first candidate determination value; when the height value of the current data point is greater than the ground height threshold, determine the target determination value according to the distance value of the current data point.

In one implementation, the target determination value determination module 502 is used to: when the distance value of the current data point is within the first distance interval, determine the target determination value as the second candidate determination value; when the distance value of the current data point is within the second distance interval, determine the target determination value as the third candidate determination value, where the maximum value of the second distance interval is less than or equal to the minimum value of the first distance interval.

In one implementation, the target determination value determination module 502 is used to: perform histogram statistics on the height values of the M data points according to N height intervals, to obtain N statistical values; and determine the upper limit value of the height interval corresponding to the maximum value of the N statistical values as the ground height threshold, where N is an integer greater than 1.

In an implementation, the noise point determination module 503 is used to: when the target determination value is greater than or equal to the determination threshold, determine that the current data point is a noise point; when the target determination value is less than the determination threshold, determine that the current data point is not a noise point.

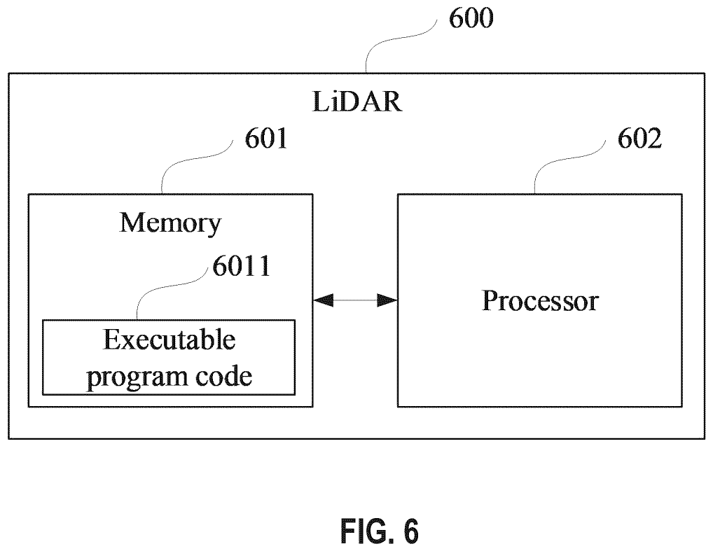

FIG. 6 is a schematic diagram of the structure of a LiDAR provided in an embodiment of the present application.

As shown in FIG. 6, the LiDAR 600 includes: a memory 601 and a processor 602, where the memory 601 stores an executable program code 6011, and the processor 602 is used to call and execute the executable program code 6011 to perform a LiDAR noise detection method.

In an embodiment, the LiDAR can be divided into functional modules according to the above method example. For example, each functional module can be corresponded, or two or more functions can be integrated into one processing module. The above integrated module can be implemented in the form of hardware. The division of modules in this embodiment is schematic and is only a logical function division.

In the case of dividing each functional module according to each function, the LiDAR may include: an acquisition module and a determination module, etc. Relevant contents of each step involved in the above method embodiment can be referred to the functional description of the corresponding functional module.

The LiDAR provided in this embodiment is used to execute the above-mentioned LiDAR noise detection method, and thus can achieve the same effect as the implementation method.

In the case of an integrated unit, the LiDAR may include a processing module and a storage module. The processing module may be used to control and manage the actions of the LiDAR. The storage module may be used to support the LiDAR in executing mutual program codes and data.

The processing module may be a processor or a controller, which may implement or execute various exemplary logic blocks, modules, and circuits. The processor may also be a combination that implements computing functions, such as a combination of one or more microprocessors, a combination of digital signal processing (DSP) and a microprocessor, etc. The storage module may be a memory.

An embodiment provides a computer-readable storage medium, which stores computer program code. When the computer program code runs on a computer, the computer executes the related method steps to implement a LiDAR noise detection method embodiment.

An embodiment provides a computer program product. When the computer program product runs on a computer, it enables the computer to execute the above-mentioned related steps to implement a LiDAR noise point detection method embodiment.

The LiDAR provided in the embodiments of the present application can be a chip, component or module, and the LiDAR may include a connected processor and memory. The memory is used to store instructions, and when the LiDAR is running, the processor can call and execute instructions so that the chip executes a LiDAR noise detection method embodiment.

The LiDAR, computer-readable storage medium, computer program product or chip provided in this embodiment are used to execute the corresponding methods provided above. Therefore, the beneficial effects that can be achieved can refer to the beneficial effects in the corresponding methods provided above.

In the embodiments provided in the present application, the disclosed devices and methods can be implemented in other ways. For example, the device embodiments described above are schematic, for example, the division of modules or units a logical function division, and there may be other division methods in actual implementation, such as multiple units or components can be combined or integrated into another device, or some features can be ignored or not executed. Another point is that the mutual coupling or direct coupling or communication connection shown or discussed can be through some interfaces, indirect coupling or communication connection of devices or units, which can be electrical, mechanical, or other forms.

What is claimed is:

1. A method for detecting noise point of a LiDAR, comprising:
obtaining a plurality of candidate determination values according to a characteristic parameter of a current data point and characteristic parameters of M data points within a neighborhood window of the current data point, wherein the M data points are other data points within the neighborhood window of the current data point except the current data point, and M is an integer greater than 1;
determining a target determination value of the current data point from the plurality of candidate determination values according to the characteristic parameter of the current data point and the characteristic parameters of the M data points; and
determining whether the current data point is a noise point, according to the target determination value.

2. The method according to claim 1, wherein the characteristic parameter comprises a distance value and a reflectivity characteristic value, and obtaining the plurality of candidate determination values according to the characteristic parameter of the current data point and the characteristic parameters of M data points within a neighborhood window of the current data point comprises:
obtaining a weighted distance difference value set, according to a distance value of the current data point, distance values of the M data points, and reflectivity characteristic values of the M data points; and
obtaining the plurality of candidate determination values according to the weighted distance difference value set.

3. The method according to claim 2, wherein obtaining the weighted distance difference value set, according to the distance value of the current data point, the distance values of the M data points and the reflectivity characteristic values of the M data points comprises:
calculating absolute values of the differences between the distance values of the M data points and the distance value of the current data point, to obtain M distance difference absolute values, and to form a distance difference set;
obtaining M weight coefficients, according to the reflectivity characteristic values of the M data points, to form a weight coefficient set; and
multiplying the absolute values of the distance differences in the distance difference set with corresponding weight coefficients in the weight coefficient set, to obtain M weighted distance difference values, to form the weighted distance difference value set.

4. The method according to claim 3, wherein obtaining the M weight coefficients, according to the reflectivity characteristic values of the M data points, to form the weight coefficient set, comprises:
when a reflectivity characteristic value Ref(i) of an ith data point meets a high reflectivity requirement, the weight coefficient is calculated as 0.5/Ref(i)^{1/2}; and
when the reflectivity characteristic value Ref(i) of the ith data point meets a low reflectivity requirement, the weight coefficient is calculated as 1/Ref(i)^{1/2}.

5. The method according to claim 2, wherein obtaining the plurality of candidate determination values according to the weighted distance difference value set comprises:
determining an average value of X weighted distance difference values with the smallest values in the weighted distance difference value set, as a first candidate determination value;
determining an average value of Y weighted distance difference values with the smallest values in the weighted distance difference value set, as a second candidate determination value; and
determining an average value of Z weighted distance difference values with the smallest values in the weighted distance difference value set, as a third candidate determination value,
wherein X<Y<Z≤M, and X, Y, and Z are all positive integers.

6. The method according to claim 5, wherein determining the target determination value of the current data point from the plurality of candidate determination values according to the characteristic parameter of the current data point and the characteristic parameters of the M data points, comprises:
when the reflectivity characteristic values of at least two data points among the M data points meet a preset requirement, determining the first candidate determination value as the target determination value; and
when the reflectivity characteristic values of at least two data points among the M data points do not meet the preset requirement, determining the target determination value according to the characteristic parameter of the current data point.

7. The method according to claim 6, wherein the characteristic parameter further comprises a height value, and determining the target determination value according to the characteristic parameter of the current data point comprises:
when a height value of the current data point is less than or equal to a ground height threshold, determining the first candidate determination value as the target determination value; and
when the height value of the current data point is greater than the ground height threshold, determining the target determination value according to the distance value of the current data point.

8. The method according to claim 7, wherein determining the target determination value according to the distance value of the current data point comprises:
when the distance value of the current data point is within a first distance interval, determining the second candidate determination value as the target determination value; and
when the distance value of the current data point is within a second distance interval, determining the third candidate determination value as the target determination value,
where a maximum value of the second distance interval is less than or equal to a minimum value of the first distance interval.

9. The method according to claim 7, wherein determining the target determination value according to the characteristic parameter of the current data point further comprises:
performing histogram statistics on the height values of the M data points according to N height intervals, to obtain N statistical values; and
determining an upper limit value of the height interval corresponding to the maximum value of the N statistical values, as the ground height threshold,
wherein N is an integer greater than 1.

10. The method according to claim 1, wherein determining whether the current data point is a noise point, according to the target determination value comprises:
when the target determination value is greater than or equal to a determination threshold, determining that the current data point is a noise point; and
when the target determination value is less than the determination threshold, determining that the current data point is not a noise point.

11. A LIDAR, comprising:
a memory, configured to store executable program code;
a processor, configured to call and run the executable program code from the memory, so that the LiDAR executes operations comprising:
obtaining a plurality of candidate determination values according to a characteristic parameter of a current data point and characteristic parameters of M data points within a neighborhood window of the current data point, wherein the M data points are other data points within the neighborhood window of the current data point except the current data point, and M is an integer greater than 1;
determining a target determination value of the current data point from the plurality of candidate determination values according to the characteristic parameter of the current data point and the characteristic parameters of the M data points; and
determining whether the current data point is a noise point, according to the target determination value.

12. A non-transitory computer-readable storage medium, storing a computer program, wherein the computer program, when executed by a processor, causes the processor to perform operations comprising:
obtaining a plurality of candidate determination values according to a characteristic parameter of a current data point and characteristic parameters of M data points within a neighborhood window of the current data point, wherein the M data points are other data points within the neighborhood window of the current data point except the current data point, and M is an integer greater than 1;
determining a target determination value of the current data point from the plurality of candidate determination values according to the characteristic parameter of the current data point and the characteristic parameters of the M data points; and
determining whether the current data point is a noise point, according to the target determination value.
